(19) United States
(12) Patent Application Publication
(10) Pub. No.: US 2002/0147754 A1
(43) Pub. Date: Oct. 10, 2002

(54) Vector difference measures for data classifiers

(76) Inventors: Derek M. Dempsey, London (GB); Kate Butchart, Stevenage (GB); Mark Preston, Enfield (GB)

Correspondence Address: The Patent Group, Foley Hoag & Eliot LLP, One Post Office Square, Boston, MA, 02109, US

(21) Appl. No.: 09/773,115

(22) Filed: Jan. 31, 2001

(51) Int. Cl. G06F 7/50

(52) U.S. Cl. 708/671

(57) ABSTRACT

A method and apparatus are provided for forming a measure of difference between two data vectors, in particular for use in a trainable data classifier system. An association coefficient determined for the two vectors is used to form the measure of difference. A geometric difference between the two vectors may advantageously be combined with the association coefficient in forming the measure of difference. A particular application is the determination of conflicts between items of training data proposed for use in training a neural network to detect telecommunications account fraud or network intrusion.

### FIELD OF THE INVENTION

The present invention relates to methods and apparatus for determining measures of difference or similarity between data vectors for use with trainable data classifiers, such as neural networks. One specific field of application is that of fraud detection including, in particular, telecommunications account fraud detection.

### BACKGROUIND TO THE INVENTION

Anomalies are any irregular or unexpected patterns within a data set. The detection of anomalies is required in many situations in which large amounts of time variant data are available. One application for anomaly detection is the detection of telecommunications fraud. Telecommunications fraud is a multi-billion dollar problem around the worlds For example, the Cellular Telecoms Industry Association estimated that in 1996 the cost to US carriers of mobile phone fraud alone was $1,6 million per day, a figure rising considerably over subsequent years. This makes telephone fraud an expensive operating cost for every telephone service provider in the world. Because the telecommunications market is expanding rapidly the problem of telephone fraud is set to become larger.

Most telephone operators have some defence against fraud already in place. These may be risk limitation tools making use of simple aggregation of call attempts or credit checking, and tools to identify cloning or tumbling. Cloning occurs where the fraudster gains access to the network by emulating or copying the identification code of a genuine telephone. This results in a multiple occurrence of the telephone unit. Tumbling occurs where the fraudster emulates or copies the identification codes of several different genuine telephone units.

Methods have been developed to detect each of these particular types of fraud. However, new types of fraud are continually evolving and it is difficult for service providers to keep ahead of the fraudsters. Also the known methods of detecting fraud are often based on simple strategies which can easily be defeated by clever thieves who realise what fraud detection techniques are being used against them.

Another method of detecting telecommunications fraud involves using neural network technology. One problem with the use of neural networks to detect anomalies in a data set lies in pre-processing the information to input to the neural network. The input information needs to be represented in a way which captures the essential features of the information and emphasises these in a manner suitable for use by the neural network itself. The neural network needs to detect fraud efficiently without wasting time maintaining and processing redundant information or simply detecting noise in the data. At the same time, the neural network needs enough information to be able to detect many different types of fraud including types of fraud which may evolve or become more prevalent in the future. As well as this the neural network should be provided with information in such a way that it is able to allow for legitimate changes in user behaviour and not identify these as potential frauds.

The input information for a neural network, for example to detect telecommunications fraud, may generally be described as a collection of data vectors. Each data vector is a collection of parameters, for example relating to total call time, international call time and call frequency of a single telephone in a given time interval. Each data vector is typically associated with one or more outputs. An output may be as simple as a single real parameter indicating the likelihood that a data vector corresponds to fraudulent use of a telephone.

A predefined training set of data vectors are used to train a neural network to reproduce the associated outputs. The trained neural network is then used operationally to generate outputs from new data vectors. From time to time the neural network may be retrained using revised training data sets. A neural network may be considered as defining a mapping between a poly dimensional input space and an output space with perhaps only one or two dimensions.

There are a number of situations arising during the use of a neural network when it may be desirable or necessary to establish the degree of similarity or difference between two data vectors. The presence in a training data set of two or more very similar data vectors having quite different corresponding outputs is undesirable, since to train the neural network to adequately reflect both data vectors and their outputs may distort the mapping between input and output space to an unacceptable extent. Furthermore, using such a data set to train a neural network to a given performance level such as a maximum allowable RMS error may result in a neural network that is relatively impervious to future training. Effective difference measures between data vectors are therefore required in order to detect and resolve conflicting training data. Similarly, effective difference measures are needed to prune training data sets, removing redundancy and thereby providing a more even coverage of the input space.

U.S. patent application Ser. No. 09/358,975 relates to a method for interpretation of data classifier outputs by associating an input vector with one or more nearest neighbour training data vectors. Each training data vector is linked to a predefined “reason”, the reasons of the nearest neighbour training data vectors being used to provide an explanation of the output generated by the neural network. To link an input vector with the most appropriate reasons requires an effective measure of difference between the input and training data vectors,

A number of different measures for use in determining the similarity or difference between data vectors for input into trainable data classifiers are already known. One of the most straightforward of these is the Euclidean, or simple geometric distance between two vectors. However, the prior art difference measures have been found to be generally inadequate to fulfil many requirements, such as those mentioned above. The present invention seeks to address these and other problems of the related prior art.

### SUMMARY OF THE INVENTION

Accordingly, the present invention provides a method of forming a measure of difference or similarity between first and second data vectors for use in a trainable data classifier system, the method comprising the steps of: determining an association coefficient of the first and second data vectors; and forming said measure of difference or similarity using said association coefficient.

The expression “vector” is used herein as a general term to describe a collection of numerical data elements grouped together. The expression “association coefficient” is used in a general sense to mean a numerical summation of measures of correlation of corresponding elements of two data vectors. Typically, this may be achieved by a quantisation of elements of the two vectors into two levels by means of a threshold, followed by a counting of the number of elements quantised into a particular one of the levels in both of the vectors, to yield a “binary” association coefficient. Some specific examples of association coefficients are given below.

It is found that the use of association coefficients in determining measures of vector difference or similarity provides significant benefits over methods used in the prior art relating to trainable classifiers, such as geometric distance.

The method may advantageously be used for a variety of purposes, for example in the retraining of a trainable data classifier that has already been trained using a plurality of data vectors making up a training data set. Association coefficients of a new data vector with one or more of the data vectors of the training data set may be used to form measures of conflict between the new data vector and the vectors of the training data set. These measures of conflict may then be used, for example, to decide whether the new data vector should be added to the training data set or used to retrain the trainable data classifier, or whether one or more vectors of the training data set should be discarded if the new data vector is added. Conveniently, such decisions may be based on a comparison of the measures of conflict with a predetermined threshold. This use of the method is more extensively discussed in copending U.S. patent application ______, entitled “Retraining Trainable Data Classifiers”, filed on the same day as the present application, the content of which is included herein by reference.

The method may also be used to operate a trainable data classifier that has been trained using a plurality of training data vectors which are associated with a number of “reasons” with the aim of associating one or more such reasons with an output provided by the data classifier, by way of explanatory support of the output. The data classifier is supplied with an input data vector and provides a corresponding output. Association coefficients between the input data vector and one or more vectors from the training data set previously used to train the data classifier are determined. These association coefficients are used to form measures of similarity in order to associate the input data vector with one or more nearest neighbours in the training data set. The reasons associated with these nearest neighbours may then be supplied to a user along with the output. The similarity or difference between the nearest neighbours and the input data vector may be used to provide a degree of confidence in each reason.

The method may also be used to address the issue of redundancy in a training data set for use in training a data classifier, by forming measures of redundancy between data vectors in the training data set using association coefficients between such data vectors. The training data set may then be modified based on the measures of redundancy, for example by discarding data vectors from densely populated volumes of vector space. This process may be carried out, for example, with reference to a predetermined threshold of data vector similarity or difference, or of vector space population density.

Preferably the association coefficient is a Jaccard's coefficient, but may be a similar coefficient representative of the number of like elements in two vectors which are of similar significance, such as a paired absence coefficient. The significance may be based on a quantisation or other simplification of the elements of each vector, for example into two discrete levels with reference to a threshold. Separate positive and negative thresholds may be used for vectors having elements which initially have values which may be either positive or negative.

Advantageously, the association coefficient of two vectors may be combined with a geometric measure of difference or similarity between the vectors. This geometric measure is preferably a Euclidean or other simple geometric distance, but may also be a geometric angle, or other measure. The association coefficient and geometric measure may be combined in a number of ways. Advantageously they may be combined in exponential relationship with each other, in particular by multiplying a function of the geometric measure with a function of the association coefficient or vice versa, with the inclusion of constants as required.

The invention also provides a data classifier system arranged to carry out the steps of the methods described above. The data classifier system comprises a data classifier operable to provide an output responsive to either of first or second data vectors; and a data processing subsystem operable to determine an association coefficient of said first and second data vectors, to thereby form a measure of difference or similarity between said vectors, for example as described above.

Preferably, the data processing subsystem is further operable to determine a geometric distance between the first and second data vectors, and to form said measure of difference by combining the association coefficient and the geometric distance, for example as described above.

Preferably, the data classifier is a neural network.

Advantageously, the data classifier system may form a part of a fraud detection system, and in particular a telecommunications account fraud detection system, in which case the data vectors may contain telecommunications account data processed appropriately for use by the data classifier system.

Advantageously, the data classifier system may form a part of a network intrusion detection system, and in particular a telecommunications or data network intrusion detection system.

The methods and apparatus of the invention may be embodied in the operation and configuration of a suitable computer system, and in software for operating such a computer system, carried on a suitable computer readable medium.

### DETAILED DESCIPTION OF THE INVENTION

As discussed above, measures of similarity or difference between data vectors are required for a number of different purposes in the training and use of trainable data classifiers. A trainable data classifier, such as a neural network, may itself operate on the basis of a similarity assessment, but this process is likely to be complex and dependant upon the training given. Processes such as management of training data conflict or redundancy, or nearest neighbour reasoning, require a more straightforward method of data vector comparison.

The elements of data input vectors may be qualitative or quantitative. In the case of telecommunications behavioural data the data is generally quantitative. The simplest similarity measure that is commonly used for real-valued data vectors is the Euclidean distance. This is the square root of the sum of the squared differences between corresponding elements of the data vectors being compared. This method, although robust, frequently identifies inappropriate pairs of vectors as nearest neighbours. It is therefore necessary to consider other methods and composite techniques.

An alternative type of difference or similarity measure not previously used in the field of trainable data classifiers is that of association coefficients. Association coefficients generally relate to the similarity or otherwise of two data vectors, the data vectors typically being first quantized into two discrete levels. Usually, all elements having values above a given threshold are considered to be present, or significant, and all elements having values below the threshold are considered to be absent or insignificant. Clearly there is an degree of arbitrariness about the threshold value used which will vary from application to applications

The use of association coefficients may be considered by reference to a simple association table, as follows:

TABLE 1

data vector 1

| | | 1 | 0 |
|---|---|---|---|
| data | 1 | a | b |
| vector | 0 | c | d |
| 2 | | | |

In table 1, a “1” indicates the significance of a vector element, and “0” indicates its insignificance. The counts a, b, c and d correspond to the number of vector elements in which the two vectors have the quantized values indicated. For example, if there were 10 elements where both vectors are zero, insignificant, or below the defined threshold, then d =10.

Association coefficients generally provide a good measure of similarity of shape of two data vectors, but no measure of quantitative similarity of comparative values in given elements.

A particular association coefficient that can be used to determine data vector similarity or difference is the Jaccard's coefficient. This is defined as:

$$S = \frac{a}{a + b + c}$$

Where a, b and c refer to the associations given in table 1 above.

The Jaccard's coefficient has a value between 0 and 1, where 1 indicates identity of the quantized vectors and 0 indicates maximum dissimilarity.

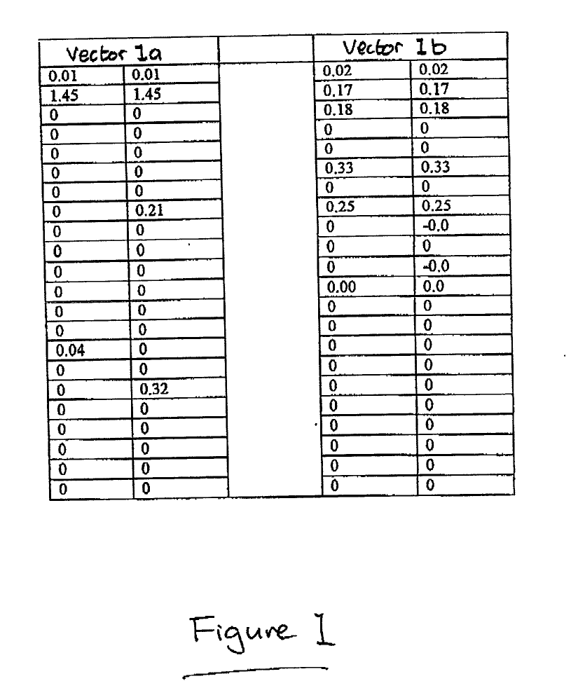

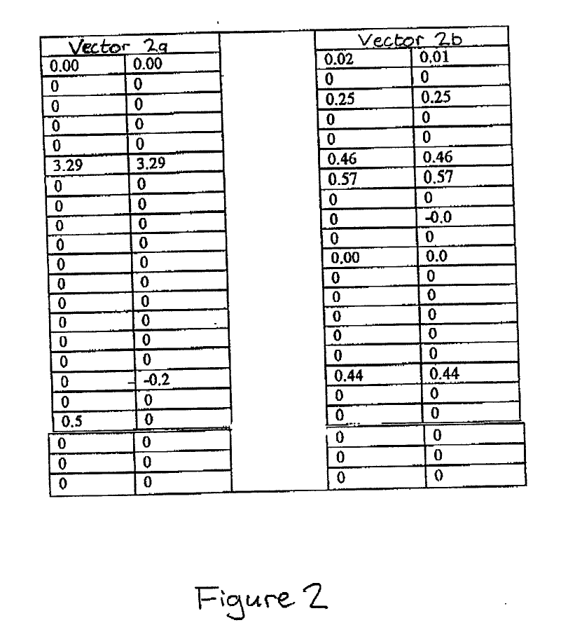

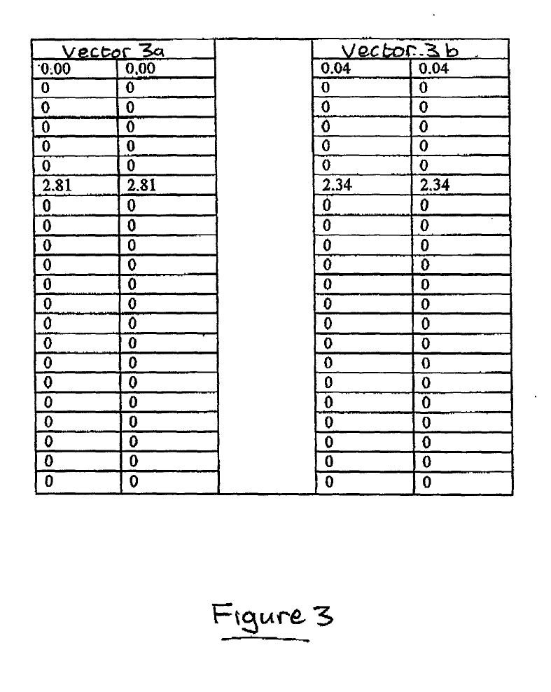

The Jaccard's coefficient and Euclidean distance will now be compared for three pairs of data vectors drawn from actual telecommunications fraud detection data. The data vector pairs are shown in FIGS. 1, 2 and 3. Each data vector has 44 elements, shown in two columns for compactness. The data vectors of FIG. 1 are referred to as vectors la and lb. Those of FIG. 2 are referred to as vectors 2a and 2b. Those of FIG. 3 are referred to as vectors 3a and 3b.

The Euclidean distance between data vectors 1a and 1b is 1.96. The Euclidean distance between data vectors 2a and 2b is 4.20. The Euclidean distance between data vectors 3a and 3b is 0.66. The corresponding Jaccard's coefficients, based on a threshold value of 0.1, are 0.42, 0.27 and 0.50 respectively.

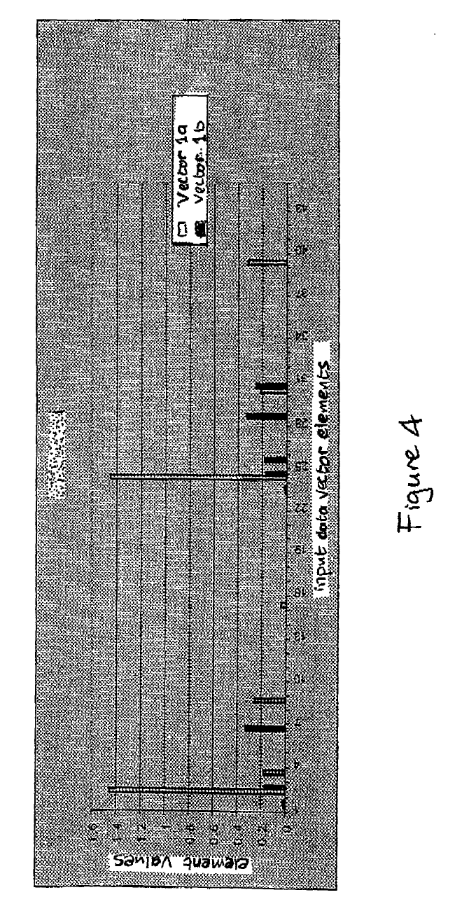

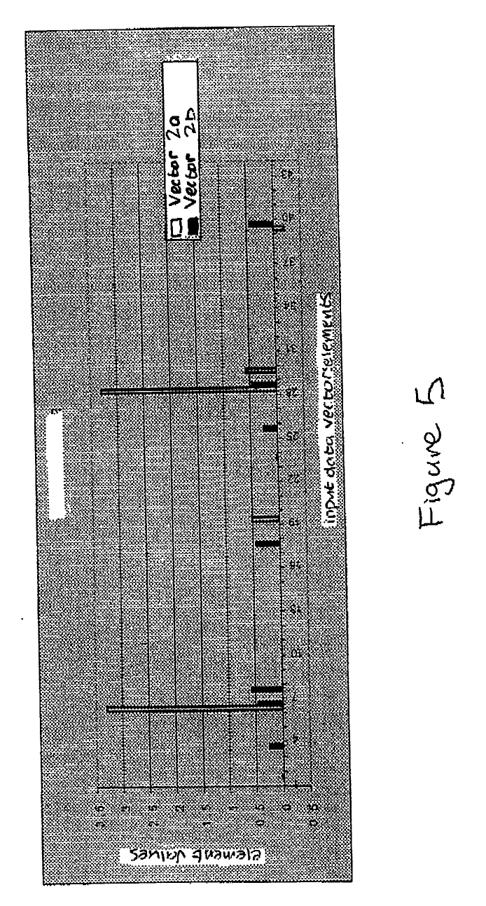

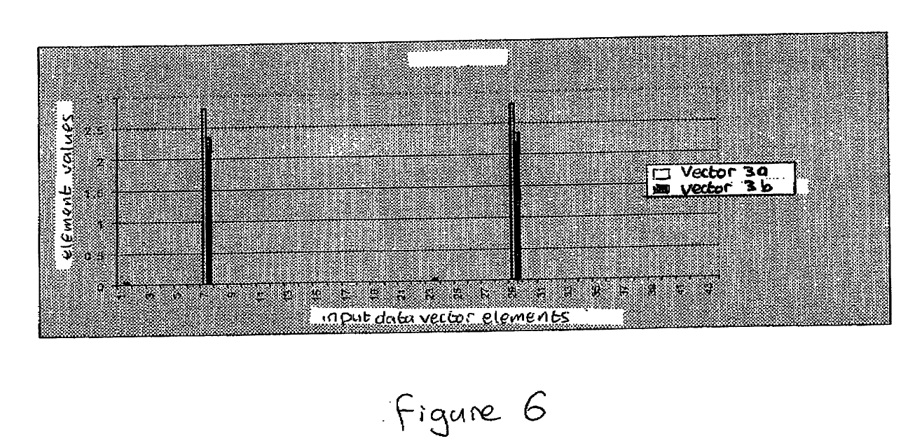

For convenient comparison, the data vectors of FIGS. 1, 2 and 3 are illustrated graphically in FIGS. 4, 5 and 6 respectively. Visual comparison of these three figures suggests that vectors 3a and 3b should be shown as very similar with neither of the 1a, 1b or 2a, 2b pairs being indicated as particularly close. The pair or vectors 2a and 2b appear to be the least similar of the three pairs. The Jaccard's coefficients do support this, although perhaps not to the degree expected. Nevertheless, the ranking is correct.

A more generalised association coefficient scheme needs to accommodate negative values that may appear in the data vectors. Conveniently, negative values may follow the same logic as positive values, a value being significant if it is below a negative threshold.

It is not necessary for this threshold to have the same absolute value as the positive threshold but it may do so.

The following more complex association table may then be defined for calculating the Jaccard's coefficient using the formula given above:

TABLE 2

data vector 1

| | | 1 | −1 | 0 |
|---|---|---|---|---|
| data | 1 | a | b | b |
| vector | −1 | c | a | b |
| 2 | 0 | c | c | d |

An alternative to the Jaccard's coefficient is a paired absences coefficient, given by:

$$T = \frac{a + d}{a + b + c + d}$$

Where a, b, C and d refer to the entries in tables 1 and 2 above. However, in sets of relatively sparsely populated data vectors typical of telecommunications fraud detection data, there tend to be large numbers of paired absences, For the three examples of FIGS. 1, 2 and 3, the value of T from the equation given above would be 0.84, 0.82 and 0.95 respectively. These coefficients appear too large and exaggerate the degree or similarity in this context. The Jaccard's coefficient results appear preferable.

Another alternative association coefficient scheme using real or binary variables is known as Gower's coefficient. This requires that a value for the range of each real variable in the data vectors is known. For binary variables, Gower's coefficient represents a generalisation of the two methods outlined above.

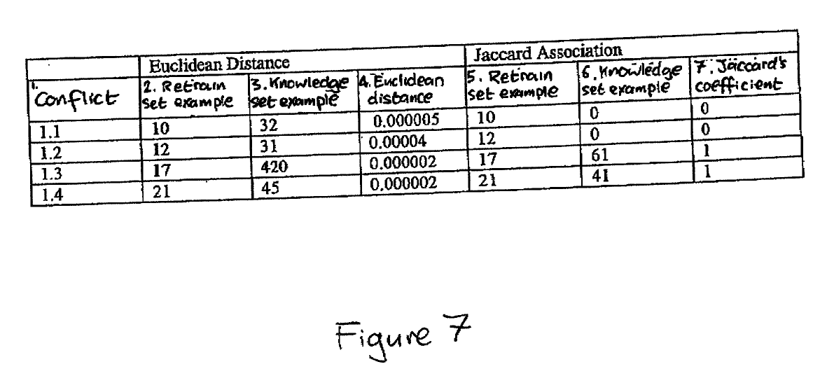

An experiment was carried out to assess the suitability of using the simple Euclidean distance and the Jaccard's association coefficient in detecting conflict between data vectors taken from genuine telecommunications fraud detection data. The two schemes were used to detect data vectors from a “retrain set” of 109 examples which were in conflict with data vectors from a “knowledge set ” of 1429 examples. Each example consisted of an input data vector and a corresponding output. The Euclidean distance and Jaccard's coefficient algorithms used were therefore to seek input data vectors from the knowledge set which were very similar to a particular input data vector from the retrain set, and yet which differed significantly in the associated output, for example as to whether the particular input data vectors represented fraudulent telecommunications activity or not. FIG. 7 illustrates some example input data vector pairings made during the experiment.

FIG. 7 shows a table having four rows, each detailing a conflict found between examples in the retrain and knowledge data sets using the Euclidean distance method. The conflicts are numbered 1.1 to 1.4 (first column). Column 2 lists the indices of four examples from the retrain set which were found to conflict with the four examples from the knowledge set listed in column 3. The Euclidean distances between the input data vectors of the conflicting examples are shown in column 4.

The conflicts found using the Euclidean distance measure are of two types. Conflicts 1.1 and 1.2 are both examples where the retrain set input data vectors (10, 12) and knowledge set input data vectors (32, 31) are of very small magnitude, perhaps representing very low telecommunications activity. The fraud significance of the retrain input data vectors is small and, having regard to the conflict, there appears to be little benefit in adding these retrain vectors to the knowledge set for retraining a data classifier.

Conflicts 1.3 and 1.4 are much more significant. Both are cases of significant telecommunications activity in which the retrain set input data vectors (17, 21) contradict examples 420 and 45 from the knowledge set, An operational decision is required as to which example from each conflicting pair is to be maintained in the knowledge set and used for subsequent retraining of a data classifier.

Columns 5, 6 and 7 show that, although conflict for retrain set examples 17 and 21 was also found using the JaccArd's coefficient method, no such conflict was found for retrain set examples 10 and 12. The fact that the Jaccard's coefficient method selected different conflicting examples from the knowledge set is a result of the algorithm used reporting only the first of several conflicting examples of equal rank.

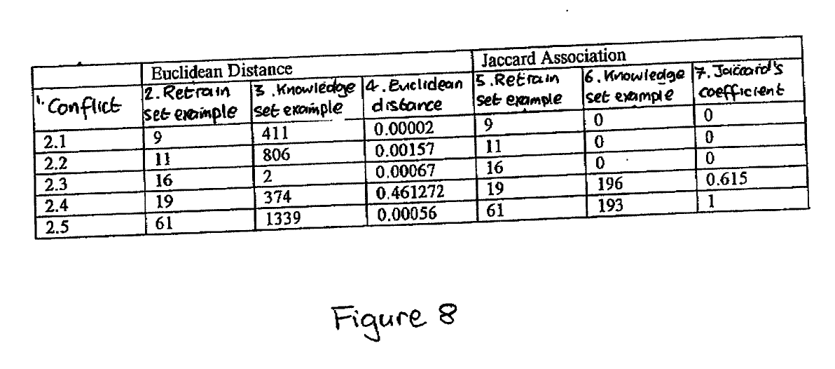

FIG. 8 illustrates some further examples of conflicts between the retrain and knowledge data sets. The layout of the table shown is the same as for FIG. 7. Conflicts 2.1, 2.2 and 2.3 are all cases where the input data vectors are of small magnitude, in which low activity telecommunications behaviour is classified as fraudulent in the retrain set. These retrain data vectors can be safely discarded. There are several significant elements in the input data vectors of conflict 2.4 and strong similarity in behaviour. The input data vectors of conflict 2.5 are close to identical.

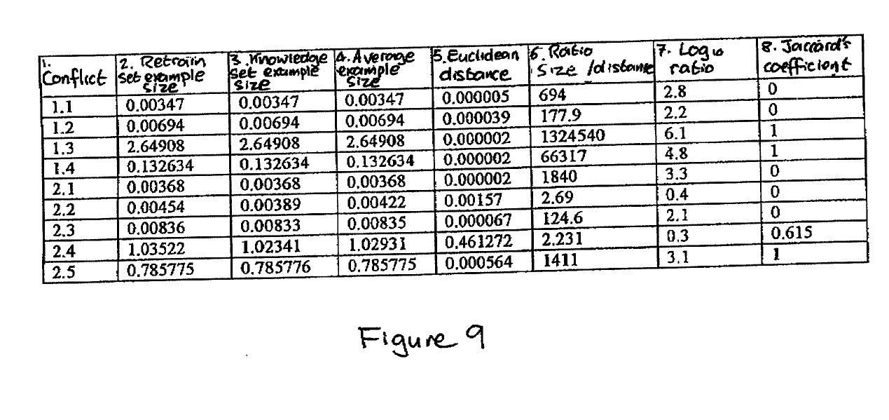

A further measure that may be used in determining conflict between data vectors is the actual Euclidean size of the vectors. The table of FIG. 9 lists, in columns 2 and 3, the Euclidean sizes (magnitudes) of the conflicting retrain set and knowledge set input data vectors from columns 2 and 3 of the tables of FIGS. 7 and 8. The average Euclidean sizes of the two input data vectors of each conflicting example pair, the Euclidean distance between them, the ratio of average size to Euclidean distance, and the base 10 log of this ratio are listed in columns 4-7. These values may be compared against the relevant Jaccard's coefficients given in column 8. It can be seen that the use of Euclidean distances alone does not appear to be as consistent in yielding suitable results as the Jaccard's coefficient.

Combinations of geometric and association coefficient measures, and in particular, but not exclusively, of Euclidean distance and Jaccard's coefficient measures provide improved measures of data vector similarity or difference for use in telecommunications fraud applications. Two possible types of combination are as follows. The first is numerical combination of two or more measures to form a single measure of similarity or distance. The second is sequential application. A two stage decision process can be adopted, using one scheme to refine the results obtained by another. Since numerical values are generated by both geometric and association coefficient measures it is a more convenient and versatile approach to adopt an appropriate numerical combination rather than using a two stage process.

While geometric measures such as Euclidean distance are generally of larger magnitude for dissimilar data vectors, the converse is generally true for association coefficients which tend to be representative of similarity. Consequently, if the geometric and association measures are to be given equal or similar priority then a simple ratio, using optional constants, can be used. This will tend to lead to some problems with division by stall numbers, but these problems may be surmounted. If one or other of the geometric and association measures is to be accorded preference then the combination can be achieved by taking a logarithm or exponent of the less important measure.

Two further methods of combination are to multiply the geometric or Euclidean distance E by the exponent of the negated association or Jaccard coefficient measure S (“modified Euclidean”), and to multiply the association or Jaccard coefficient S by the exponent of the negated geometrical Euclidean distance E (“modified Jaccard”), with the inclusion of suitable constants k₁ and k₂ as follows:

Modified Euclidean: D=E exp(−k, S)

Modified Jaccard: R=S exp(−k₂E)

Other suitable constants may, of course, be introduced to provide suitable numerical trimming and scaling, and of course functions other than exponentials, such as other power functions could equally be used.

A number of further experiments carried out on genuine telecommunications account fraud data are described in the appendix. In these experiments a number of different combinations of the Jaccard's coefficient and the Euclidean distance were used, including two different weightings of the Euclidean distance in a Euclidean modified Jaccard measure.

A number of situations in the training and operation of a trainable data classifier in which similarities or differences between data vectors need to be assessed will now be described with reference to the techniques disclosed above. Conflict assessment is a case of similarity assessment where training input data vectors are identified as being very similar, but where they have been classified as having quite different correspond outputs. For example, first and second telecommunications behaviour input data vectors which are very similar may be known to correspond to fraudulent and non-fraudulent behaviour respectively. A neural network or other data classifier may be able to accommodate some conflicting training data of this type, but for a fraud detection product it is important that the neural network or other classifier preserves a relatively unambiguous mapping from the input to the output space. A human fraud analyst may be required to sort out inevitable ambiguities and conflicts. Experiments indicate that the Jaccard modified Euclidean measure, or more generally a geometric measure modified by an association coefficient provides improved means for assessing conflicts between training data vectors.

One of the difficulties of using neural networks and other trainable data classifiers commercially has been to achieve user or customer acceptance without being able to provide any reason or justification for decisions produced by the data classifier. “Reasons” for a particular neural network output can be provided by association of the input data vector to the nearest data vectors in the training data set. “Reasons” or other explanatory material linked to the vectors of the training data set can be provided to the user, along with a confidence level derived from the proximity of the relevant training data vector to the input data vector. This technique may be referred to as “nearest neighbour reasoning”.

Trained neural networks tend to provide a complex mapping between input and output spaces. This mapping is generally difficult to reproduce using standard rule-based techniques. The matching needed in nearest neighbour reasoning may be between a input data vector indictive of a potential telecommunications fraud that has been detected by the neural network and data vectors in the training data set. The matching between these must be very reliable to provide adequate customer confidence in the nearest neighbour reasoning process. In this context, Euclidean distance measures are found to be particularly poor. Combining geometric and association coefficient measures successfully redresses the inadequacies of the simple Euclidean measure and provides an improved nearest neighbour reasoning process.

A training data vector set for training a neural network may contain a considerable amount of duplication, with some volumes of the input vector space being much more densely populated than others. If there is too much duplication then conflict with a new data vector to be introduced to the training set may require the removal of large numbers of examples from the training set. In addition, there are advantages, for example in speed and subsequent performance, in training and retraining a data classifier from a smaller training data set. Redundancy checking seeks to prune the input data vector space of the training data set to remove duplicate or near-duplicate data vectors.

In practice, the Jaccard modified Euclidean scheme described above tends to find more near-duplicate data vectors amongst low valued non-fraud input data vectors than in other regions of input data vector space of telecommunications fraud data. However, the differential is not acute and the Jaccard modified Euclidean scheme has proven effective for use in redundancy checking. The use of a Euclidean modified Jaccard scheme is not very appropriate for redundancy checking since low magnitude data vectors tend to be overlooked leading to a strong bias towards the redundancy pruning of larger magnitude data vectors. This results in an unbalanced training data set.

Experimental results, such as those described above, indicate that the Jaccard's coefficient tends to perform better than the Euclidean distance in the identification of similar data vectors in potentially fraudulent telecommunications behaviour data. From this point of view, the Euclidean modified Jaccard measure described above might appear to be preferable for general use over the Jaccard modified Euclidean measure. However, the former measure does not perform well with data vectors of small magnitude. While this is unlikely to be a concern for nearest neighbour reasoning where data vectors of concern tend to relate to significant telecommunications activity, there are some disadvantages of the Euclidean Modified Jaccard measure, particularly in redundancy checking, as described above.

Although it is not essential to employ the same difference or similarity measure for all purposes in a particular trainable data classifier system, the use of a common measure will generally be preferred for consistency and simplicity. In particular for telecommunications fraud detection, the above mentioned Jaccard modified Euclidean measure, and similar association coefficient modified geometric measures appear to be preferable over Euclidean modified Jaccard or similar geometric modified association measures.

The Jaccard modified Euclidean measure is easy to use, requires only one global threshold to define the significance level, and combines two types of similarity measure, association and distance, deriving benefits from both and, importantly, minimising the drawbacks of each method. This and similar measures may be used for any case-based reasoning where the data is largely or entirely numeric.

Alternative Similarity Measures

Another measure of vector similarity which may be used is the angle between two data vectors. This may be evaluated as a direction cosine having a value between 1 and 0, 1 indicating a “best match”. Equally, the range of the direction cosine could be between 1 and −1 to take account of obtuse angles. Yet another possible measure is the “Tanimoto” measure, derived from set theory, which has been used as a measure of relevance between documents. However, neither of these methods has proved more suitable in the assessment of the similarity of telecommunications fraud data vectors than the more straightforward Euclidean distance.

Appendix

Several scoring methods were examined and their consequences considered in relation to actual data, in particular in relation to possible conflicts and possible identifiers. These results simply present the numerical calculations made and their interpretation has been used in the assessment in the main text. These methods with some sample scores computed are:

1. Jaccard similarity coefficient with euclidean modifier
Similarity Coefficient = Jacc * exp(−dist)
The most significant numerical value is that associated with a conflict. It is
assumed that a jaccard value of greater than 0.5 is necessary and that the
Euclidean distance needs to be small. If a jaccard of 0.67 and a Euclidean
distance of 0.125 is defined as a conflict threshold this gives a conflict
threshold or 0.59 for the combined result.

| | | | | Comments |
|---|---|---|---|---|
| Jaccard | Euclidean | Exp(−dist) | SC | (Assume 0.59 for conflict) |
| 0.5 | 0.125 | 0.882 | 0.441 | No conflict |
| 0.75 | 0.125 | | 0.662 | Conflict |
| 0.2 | 0.125 | | 0.177 | |
| 0.2 | 0.15 | | 0.172 | |
| 1 | 0.25 | | 0.780 | Conflict |
| 1 | 0.206 | | 0.815 | Conflict |
| 0.75 | 0.6 | | 0.412 | |
| 0.3 | 0.3 | | 0.222 | |
| 0.3 | 0.1 | | 0.272 | |
| 0.3 | 0.05 | | 0.286 | |
| 1 | 0.3 | | 0.741 | Conflict |

| Jaccard | Euclidean | Exp(−dist) | SM | |
|---|---|---|---|---|
| 0.2 | 0.2 | 0.819 | 0.164 | |
| 0.2 | 0.1 | 0.905 | 0.182 | |
| 0.2 | 0.5 | 0.61 | 0.122 | |
| 0.2 | 0.05 | 0.95 | 0.19 | |
| 0.33 | 0.2 | 0.819 | 0.270 | |
| 0.33 | 0.1 | 0.905 | 0.299 | |
| 0.33 | 0.5 | 0.61 | 0.201 | |
| 0.33 | 0.05 | 0.95 | 0.314 | |
| 0.5 | 0.2 | 0.819 | 0.410 | |
| 0.5 | 0.1 | 0.905 | 0.453 | |
| 0.5 | 0.5 | 0.61 | 0.305 | |
| 0.5 | 0.05 | 0.95 | 0.475 | |
| 0.67 | 0.2 | | 0.549 | |
| 0.5 | 0.001 | | 0.499 | |
| 0.75 | 0.0001 | | 0.749 | Conflict |
| 1 | 0.00001 | | 0.999 | Conflict |
| 1 | 0.000001 | | 0.999 | Conflict |
| 1 | 0 | | 1 | Identity |
| 0 | 0.2 | | 0 | |
| 0.0217391 | 5.0 | | 0.00015 | |
| 0.0217391 | 50 | | 0.00000 | |
| 0.05 | 0.05 | | 0.0476 | Contradictory indicators- |
| | | | | Jaccard determines |
| 0.05 | 0.1 | | 0.0452 | Contradictory indicators |
| 0 | 0 | | 0 | Defined behaviour |

2. Revised Emphasis of the Jaccard Component
The initial formulation reduces the significance of the euclidean distance
perhaps too much. If the coefficient of 1.5 is adopted for the euclidean this
is redressed to some degree.
Similarity = Jacc * exp(−1.5*dist)
Assuming the same conflict standard of 0.67 jaccard and 0.125 euclidean
gives a lower conflict threshold of 0.55.

| | | | | Comments |
|---|---|---|---|---|
| | | Exp(− | | (Assume 0.55 is conflict |
| Jaccard | Euclidean | 1.5*dist) | SD | threshold) |
| 0.50 | 0.125 | 0.829 | 0.415 | |
| 0.75 | 0.125 | 0.829 | 0.622 | Conflict |
| 0.2 | 0.125 | 0.829 | 0.166 | |
| 0.2 | 0.15 | 0.799 | 0.160 | |
| 1 | 0.25 | 0.687 | 0.687 | Conflict |
| 1 | 0.206 | 0.734 | 0.734 | Conflict |
| 0.75 | 0.6 | 0.407 | 0.305 | |
| 0.3 | 0.3 | | 0.096 | |
| 0.3 | 0.1 | | 0.129 | |
| 0.3 | 0.05 | | 0.139 | |
| 1 | 0.3 | | 0.319 | |

| | | Exp(− | | |
|---|---|---|---|---|
| Jaccard | Euclidean | 1.5*dist) | SD | |
| 0.2 | 0.2 | | 0.148 | |
| 0.2 | 0.1 | | 0.172 | |
| 0.2 | 0.5 | | 0.095 | |
| 0.2 | 0.05 | | 0.186 | |
| 0.33 | 0.2 | | 0.245 | |
| 0.33 | 0.1 | | 0.284 | |
| 0.33 | 0.5 | | 0.156 | |
| 0.33 | 0.05 | | 0.306 | |
| 0.5 | 0.2 | | 0.370 | |
| 0.5 | 0.1 | | 0.431 | |
| 0.5 | 0.5 | | 0.236 | |
| 0.5 | 0.05 | | 0.464 | |
| 0.67 | 0.2 | | 0.497 | |
| 0.5 | 0.001 | | 0.500 | |
| 0.75 | 0.0001 | | 0.750 | Conflict |
| 1 | 0.00001 | | 0.999 | Conflict |
| 1 | 0.000001 | | 0.999 | Conflict |
| 1 | 0 | | 1 | Identity |
| 0 | 0.2 | | 0 | Defined behaviour |
| 0.0217391 | 5.0 | | 0.00001 | Probable max dissimularity |
| 0.0217391 | 50 | | 0.00000 | |
| 0.05 | 0.05 | | 0.047 | Contradictory indicators- |
| 0.05 | 0.1 | | 0.043 | Contradictory indicators |
| 0 | 0 | | 0 | Defined behaviour |

3. Comparison of three scoring methods:
SQ1 = Jacc/4 * dist
SQ2 = Jacc * exp (−dist)
SQ3 = Jacc * exp (−1.5 * dist)
SQ4 = exp (−jacc/dist)

| | | | | | | Com- |
|---|---|---|---|---|---|---|
| Jaccard | Euclidean | SQ1 | SQ2 | SQ3 | SQ4 | ments |
| 1 | 0.206 | 0.1213 | 0.815 | 0.734 | 0.616 | All |
| 1 | 0.25 | 0.1472 | 0.780 | 0.687 | 0.555 | C2 and |
| | | | | | | C3 |
| 1 | 0.3 | 0.1766 | 0.741 | 0.638 | 0.493 | C2 and |
| | | | | | | C3 |
| 0.75 | 0.125 | 0.0944 | 0.662 | 0.622 | 0.686 | All |
| 1 | 0.4 | | | 0.549 | | |
| 1 | 0.5 | | | 0.472 | | |
| 0.5 | 0.125 | 0.1213 | 0.441 | 0.415 | 0.616 | C1 only |
| 0.75 | 0.6 | 0.4534 | 0.412 | 0.305 | 0.163 | |
| 0.2 | 0.125 | 0.1637 | 0.177 | 0.166 | 0.520 | |
| 0.2 | 0.15 | 0.2619 | 0.172 | 0.160 | 0.351 | |
| 0.3 | 0.05 | 0.0592 | 0.286 | 0.139 | 0.789 | C1 only |
| 0.3 | 0.1 | 0.1186 | 0.272 | 0.129 | 0.621 | C1 only |
| 0.3 | 0.3 | 0.3555 | 0.222 | 0.096 | 0.241 | |
| 1 | 0 | 1000000 | 1 | 1 | 0 | All |
| 1 | 0.00001 | 25000 | 0.999 | 0.999 | 0 | All |
| 1 | 0.000001 | 250000 | 0.999 | 0.999 | 0 | All |
| 0.75 | 0.0001 | 1875 | 0.749 | 0.750 | 0 | All |
| 0.5 | 0.001 | 125 | 0.499 | 0.500 | 0 | C1 |
| 0.67 | 0.2 | 0.83 | 0.549 | 0.497 | 0.0362 | |
| 0.5 | 0.05 | 2.5 | 0.475 | 0.464 | 0.00005 | |
| 0.5 | 0.1 | 1.25 | 0.453 | 0.431 | 0.0067 | |
| 0.5 | 0.2 | 0.625 | 0.410 | 0.370 | 0.0821 | |
| 0.33 | 0.05 | 1.65 | 0.314 | 0.306 | 0.0014 | |
| 0.33 | 0.1 | 0.88 | 0.299 | 0.284 | 0.0296 | |
| 0.33 | 0.2 | 0.44 | 0.270 | 0.245 | 0.172 | |
| 0.5 | 0.5 | 0.25 | 0.305 | 0.236 | 0.368 | |
| 1 | 1 | 0.25 | 0.368 | 0.223 | 0.368 | |
| 0.2 | 0.05 | 1 | 0.19 | 0.186 | 0.018 | |
| 0.2 | 0.1 | 0.5 | 0.182 | 0.172 | 0.135 | |
| 0.33 | 0.5 | 0.165 | 0.201 | 0.156 | 0.517 | |
| 0.2 | 0.2 | 0.25 | 0.164 | 0.148 | 0.368 | |
| 0.2 | 0.5 | 0.1 | 0.122 | 0.095 | 0.670 | C1 only |
| 1 | 2.0 | 0.125 | 0.135 | 0.050 | 0.607 | |
| 0.05 | 0.05 | | 0.0476 | 0.047 | | |
| 0.05 | 0.1 | | 0.0452 | 0.043 | | |
| 0.0217391 | 5.0 | 0.0543 | 0.00015 | 0.00001 | 0.805 | |
| 0 | 0.2 | 0 | 0 | 0 | 1 | |
| 0.0217391 | 50 | | 0.00000 | 0.00000 | | |
| 0 | 0 | | 0 | 0 | | |

4. Euclidean Emphasis
SO5 = dist * exp (−jacc)
This formulation takes the euclidean distance as a base and modifies it
with the jaccard. Its range is the same as the euclidean.

| Jaccard | Euclidean | Distance | Comments (conflict <0.04) |
|---|---|---|---|
| 0.2 | 0.05 | 0.0164 | Conflict |
| 0.5 | 0.05 | 0.0303 | Conflict |
| 0.33 | 0.05 | 0.0360 | Conflict |
| 1 | 0.1 | 0.0368 | Conflict |
| 0.3 | 0.05 | 0.0370 | Conflict |
| 0.5 | 0.066 | 0.0400 | |
| 1 | 0.11 | 0.0405 | |
| 1 | 0.125 | 0.0460 | |
| 0.75 | 0.125 | 0.0590 | |
| 0.5 | 0.1 | 0.0607 | |
| 0.33 | 0.1 | 0.0719 | |
| 0.3 | 0.1 | 0.0741 | |
| 0.5 | 0.125 | 0.0758 | |
| 1 | 0.206 | 0.0758 | |
| 0.2 | 0.1 | 0.0818 | |
| 1 | 0.25 | 0.0920 | |
| 0.2 | 0.125 | 0.1023 | |
| 0.67 | 0.2 | 0.1023 | |
| 1 | 0.3 | 0.1104 | |
| 0.5 | 0.2 | 0.1213 | |
| 0.2 | 0.15 | 0.1228 | |
| 0 | 0.125 | 0.125 | |
| 0.3 | 0.23 | 0.2222 | |
| 0.75 | 0.6 | 0.2834 | |

The jaccard contribution can be increased by introducing a factor to the jaccard distance exponent. This does not affect the range or possible values but will emphasize the jaccard portion within this range.

1. In a trainable data classifier, a method of forming a measure of difference between first and second data vectors, the method comprising the steps of.
determining an association coefficient of the first and second data vectors; and
forming said measure of difference using said association coefficient.

2. A method according to claim 1 wherein the association coefficient comprises a Jaccard's coefficient.

3. A method according to claim 1 wherein the association coefficient comprises a paired absence measure.

4. A method according to claim 1 further comprising a step of determining a geometric difference between the first and second data vectors, and wherein the step of forming comprises a step of combining said association coefficient and said geometric difference to thereby form said measure of difference.

5. A method according to claim 4 wherein the geometric difference comprises a Euclidean distance.

6. A method according to claim 4 wherein the geometric difference comprises a geometric angle.

7. A method according to claim 4 wherein the step of combining comprises the step of combining the geometric difference and association coefficient in exponential relationship with each other.

8. A method according to claim 7 wherein the step of combining comprises a step of multiplying a function of the geometric difference by an exponent of a function of the association coefficient.

9. A method according to claim 7 wherein the step of combining comprises a step of multiplying a function of the association coefficient by an exponent of a function of the geometric difference.

10. A method according to claim 1 wherein said trainable data classifier comprises a neural network.

11. A method according to claim 1 wherein said first and second data vectors comprise telecommunications account fraud data.

12. A method of retraining a trainable data classifier that has been trained using a plurality of data vectors including a first data vector, the method comprising the steps of:
providing a second data vector;
determining an association coefficient of the first and second data vectors;
forming a measure of conflict between said first and second data vectors using said association coefficient; and
using the second data vector to retrain the data classifier responsive to the measure of conflict.

13. A method according to claim 11 wherein the step of using the second data vector to retrain the data classifier is responsive to a predetermined conflict threshold value.

14. A method according to claim 12 further comprising a step of determining a geometric difference between the first and second data vectors, and wherein the step of forming comprises a step of combining said association coefficient and said geometric difference to thereby form said measure of conflict.

15. A method of operating a trainable data classifier, said trainable data classifier having been trained using a plurality of training data vectors, said plurality of training data vectors being associated with a plurality of reasons, the method comprising the steps of:
providing an input data vector;
generating an output responsive to the input data vector;
selecting one or more of said training data vectors;
for each selected training data vector:
determining an association coefficient of said input data vector and said selected training data vector, and
forming a measure of difference between said input data vector and said selected training data vector from said association coefficient; and
using said measures of difference to associate at least one of said reasons with said output responsive to said measures of difference.

16. A method according to claim 13 further comprising the step of presenting to a user information indicative of said output, of said at least one of said reasons, and of their association.

17. A method according to claim 13 further comprising the step of using said measures of difference to associate with at least one reason a degree of confidence with which said reason is associated with said input data vector.

18. A method according to claim 15 further comprising a step of determining a geometric difference between said input data vector and said selected training data vector, and wherein the step of forming comprises a step of combining said association coefficient and said geometric difference to thereby form said measure of difference.

19. A method of training a trainable data classifier comprising the steps of;
providing a training data set comprising at least first and second data vectors;
determining an association coefficient of said first and second data vectors;
forming a measure of redundancy between said first and second data vectors from said association coefficient;
modifying said training data set responsive to said measure of redundancy; and
training said trainable data classifier using said modified training data set.

20. A method according to claim 19 wherein the step of forming a measure of redundancy is carried out with reference to a predetermined redundancy threshold value.

21. A method according to claim 19 further comprising the step of discarding one of said first and second data vectors responsive to said measure of redundancy.

22. A method according to claim 19 further comprising a step of determining a geometric difference between said first and second data vectors, and wherein said step of forming comprises a step of combining said association coefficient and said geometric difference to thereby form said measure of redundancy.

23. A data classifier system comprising:
a data classifier operable to provide an output responsive to either of first or second data vectors; and
a data processing subsystem operable to determine an association coefficient of said first and second data vectors, to thereby form a measure of difference between said vectors.

24. A data classifier system according to claim 23 wherein the association coefficient comprises a Jaccard's coefficient.

25. A data classifier system according to claim 23 wherein the association coefficient comprises a paired absences coefficient.

26. A data classifier system according to claim 23 wherein the data processing subsystem is further operable to determine a geometric difference between said first and second data vectors, and to form said measure of difference by combining said association coefficient and said geometric difference.

27. A data classifier system according to claim 26 wherein the geometric difference comprises a Euclidean distance.

28. A data classifier system according to claim 26 wherein the geometric difference comprises a geometric angle.

29. A data classifier system according to claim 26 wherein the data processing subsystem is operable to form said measure of difference by combining said association coefficient and said geometric difference in exponential relationship with each other.

30. A data classifier system according to claim 29 wherein said data processing subsystem is operable to form said measure of difference by multiplying a function of the geometric difference by an exponent of a function of the association coefficient.

31. A data classifier system according to claim 29 wherein said data processing subsystem is operable to form said measure of difference by multiplying a function of the association coefficient by an exponent of a function of the geometric difference.

32. A data classifier system according to claim 23 wherein said data classifier comprises a neural network.

33. An anomaly detection system comprising a data classifier system according to claim 23.

34. An account fraud detection system comprising a data classifier system according to claim 23.

35. A telecommunications account fraud detection system comprising a data classifier system according to claim 23.

36. A network intrusion detection system comprising a data classifier system according to claim 23.

37. Computer software in a machine readable medium for providing at least a part of a data classifier system when executed on a computer system, the software operable to perform the steps of:
receiving first and second data vectors;
determining an association coefficient of the first and second data vectors; and
forming a measure of difference between said first and second data vectors using said association coefficient.

38. Computer software in a machine readable medium according to claim 37, further operable to perform the step of determining a geometric difference between said first and second data vectors, and to perform the step of forming by carrying out a step of combining said association coefficient and said geometric difference to thereby form said measure of difference.
